(19) United States
(12) Patent Application Publication
(10) Pub. No.: US 2025/0327474 A1
(43) Pub. Date: Oct. 23, 2025

(54) ROLLER SWAGE APPARATUSES, ROLLER SWAGE ATTACHMENTS AND RELATED METHODS

(71) Applicant: Hubbell Incorporated, Shelton, CT (US)

(72) Inventors: Matthew Scott Hocking, Bethlehem, NH (US); Shane Hopps, Whitefield, NH (US)

(21) Appl. No.: 19/183,117

(22) Filed: Apr. 18, 2025

Related U.S. Application Data
(60) Provisional application No. 63/635,799, filed on Apr. 18, 2024.

(51) Int. Cl. F16B 19/05

(52) U.S. Cl. CPC F16B 19/05

(57) ABSTRACT

The present subject matter relates to roller swage apparatuses, roller swage attachments and related methods. For example, in some embodiments, a roller swage apparatus for swaging a portion of a cylinder of material can be provided. The roller swage apparatus can comprise a spindle for holding and rotating a cylinder of material and a tool post that is movable into and out of alignment with the spindle as well as a controller for operating the spindle and the movement of the tool post. The roller swage apparatus can comprise a roller swage attachment secured to the tool post for engaging the cylinder of material to shape the cylinder of material into a desired shape.

### RELATED APPLICATIONS

The presently disclosed subject matter claims the benefit of U.S. Provisional Patent Application Ser. No. 63/635,799, filed Apr. 18, 2024, the disclosure of which is incorporated herein by reference in its entirety.

### TECHNICAL FIELD

The present subject matter relates to roller swage apparatuses, roller swage attachments and related methods. In particular, the present subject matter relates to roller swage attachments and apparatuses used to shape metal, for example, to form a lug body having a tongue portion and a barrel portion that can be formed into a lug, as well as methods related to use and assembly as described herein.

### BACKGROUND

Lugs are used as metal fittings to which electrical wires are soldered and connected that can be used for connecting electrical wires to electrical components. Lugs can be useful in ensuring electrical connection safety. Large lugs can have complications during manufacture. For example, the formation of a large lug requires producing a lug body having two or more different outer and/or inner diameters from a cylinder of a conductive metal, such as copper or aluminum, having a singular outer diameter and inner diameter. Turning the cylinder of conductive material on a lathe to create a lug body creates an excessive loss of material with a thicker walled material required. The outer diameter of the cylinder of material will need to be turned on the end of the lug body that forms a tongue end of the lug with a smaller outer diameter and the inner diameter of a barrel end of the lug will need to be drilled to create a larger inner diameter. The drilling and turning require longer cycle times as well.

For lugs produced using a die, current production tooling, such as a form die, tends to crack due to the heat generated. The process requires friction to heat the part material (i.e., copper or aluminum) to a temperature that flows this material into the die. This friction also creates high spindle loads on the CNC lathe machine.

As such, a need exists for tools and processes that can produce lug bodies that can reduce material waste, reduced cycle times, and be more cost effective that also do not produce undue wear on lug formation tools and machinery.

### SUMMARY

The present subject matter relates to roller swage apparatuses, roller swage attachments and related methods. In particular, the present subject matter relates to roller swage attachments and apparatuses used to shape metal. In some embodiments, for example, roller swage attachments and apparatuses can be used to form a lug body having a tongue portion and a barrel portion. Methods related to the use and assembly of the roller swage apparatuses and roller swage attachments disclosed herein are also provided.

Thus, it is an object of the presently disclosed subject matter to provide roller swage apparatuses, roller swage attachments, and related methods. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a perspective view of an embodiment of a lug which has a body formed using an embodiment of a roller swage apparatus with a roller swage attachment secured thereto according to present subject matter;

FIG. 2 illustrates a side plan view of an embodiment of a body of a lug formed using an embodiment of a roller swage apparatus with a roller swage attachment secured thereto according to present subject matter;

FIG. 3 illustrates a perspective view of a portion of an embodiment of a roller swage apparatus with an embodiment of a roller swage attachment secured thereto according to present subject matter;

FIG. 4A illustrates an exploded view of an embodiment of a roller swage attachment that can be used for forming a body of a lug according to present subject matter;

FIG. 4B illustrates a front plan view of an embodiment of a roller swage body of the embodiment of the roller swage attachment according to FIG. 4A;

FIG. 5 illustrates a side perspective view of an embodiment of a roller swage apparatus with an embodiment of a roller swage attachment secured thereto with a cylinder of material to be formed into a lug body secured to a spindle of the roller swage apparatus according to present subject matter;

FIG. 6 illustrates a side perspective view of the embodiment of the roller swage apparatus according to FIG. 5 with the roller swage attachment aligned with the spindle and the cylinder of material according to present subject matter;

FIG. 7 illustrates a side perspective view of the embodiment of the roller swage apparatus according to FIG. 5 with swage rollers of the roller swage attachment engaging an outer diameter of the cylinder of material as the spindle spins the cylinder of material according to present subject matter;

FIG. 8 illustrates a side perspective view of the embodiment of the roller swage apparatus according to FIG. 5 with the swage rollers of the roller swage attachment engaging further up the outer diameter of the cylinder of material elongating and reducing the outer diameter of the swaged portion of the cylinder of material according to present subject matter;

FIG. 9 illustrates a side perspective view of the embodiment of the roller swage apparatus according to FIG. 5 with the swage rollers of the roller swage attachment being moved in a direction away from the cylinder of material once a tongue portion of the lug body is formed according to present subject matter;

FIG. 10 illustrates a side perspective view of the embodiment of the roller swage apparatus according to FIG. 5 with the swage rollers of the roller swage attachment disengaged from the cylinder of material secured to the spindle with the cylinder of material formed into a lug body according to present subject matter;

FIG. 11 illustrates a side perspective view of the embodiment of the roller swage apparatus according to FIG. 5 with the roller swage attachment secured to the roller swage apparatus moved to an idle position to provide easy access to the newly formed lug body according to present subject matter;

FIG. 12 illustrates a side perspective view of the spindle of the embodiment of the roller swage apparatus according to FIG. 5 holding a newly formed lug body formed by the roller swage attachment secured to the roller swage apparatus according to present subject matter; and

FIG. 13 illustrates an exploded perspective view of an embodiment of a roller swage attachment according to present subject matter.

Repeat use of reference characters in the present specification and drawings is intended to represent the seam or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only, and is not intended as limiting the broader aspects of the present subject matter, which broader aspects are embodied in exemplary constructions.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

As used herein, the terms “controller” and “computing device” are synonymous and mean one or more desktop computers, programmable logic controller (PLC), laptop computers, set-top devices, tablet computers, mobile devices, mobile smart devices, smartphones, wearable devices, servers, and/or the like. In some embodiments, the computing device may be provisioned with a hardware-based processor that is configured to execute software programs or applications.

The present subject matter relates to roller swage apparatuses, roller swage attachments and related methods. In particular, the present subject matter relates to roller swage attachments and apparatuses used to shape metal as well as methods related to use and assembly as described herein. For example, in some embodiments, a roller swage apparatus for swaging a portion of a cylinder of material to form a lug body can be provided. The roller swage apparatus can comprise a spindle for holding and rotating a cylinder of material and a tool post that is movable into and out of alignment with the spindle as well as a controller for operating the spindle and the movement of the tool post. The roller swage apparatus can comprise a roller swage attachment secured to the tool post for engaging the cylinder of material to shape the cylinder of material into a lug body. While the swage roller apparatuses and swage roller attachments disclosed herein are described in reference to lugs and lug bodies, the swage roller apparatuses and swage roller attachments can be used to form other parts and components that can be made through swaging.

For example, an embodiment of a roller swage attachment can comprise a roller swage body having a spindle facing surface and a receiving channel extending through the spindle facing surface within the roller swage body. The roller swage attachment can comprise a plurality of swage rollers extending from the spindle facing surface of the roller swage body with the plurality of swage rollers being rotatable relative to the roller swage body. Each of the plurality of swage rollers can be positioned about the receiving channel. When a rotating cylinder of material to be treated is spun about an axis of the cylinder of material, aligned with the receiving channel and then moved toward the receiving channel of the roller swage body, the plurality of swage rollers contact a portion of an outer diameter of the rotating cylinder of material as the cylinder of material is rotated causing the portion of the outer diameter contacted by the plurality of swage rollers to be reduced.

In some embodiments, the roller swage attachment can comprise a plurality of swage posts extending from the spindle facing surface of the roller swage body. Each swage post is located in a different position around the receiving channel. Each of the plurality of the swage rollers can be secured on a corresponding swage post of the plurality of swage posts such that the respective swage roller can be rotatable about the corresponding swage post. Each of the plurality of the swage rollers can be positioned about the receiving channel and can extend outward from the spindle facing surface of the roller swage body such that, when a rotating cylinder of material to be treated is spun about an axis of the cylinder, aligned with the receiving channel, and then moved toward the receiving channel of the roller swage body, the plurality of swage rollers contact a portion of an outer diameter of the rotating cylinder of material as the cylinder is rotated causing the portion of the outer diameter to be contacted by the plurality of swage rollers. In this manner, the cylinder of material can be formed into a lug body with a barrel portion having the same outer diameter as the cylinder of material and a tongue portion having a reduced outer diameter with a transition portion between the barrel portion and the tongue portion of the lug body.

Additionally, in some embodiments, a roller swage attachment for securing to a roller swage apparatus can be provided. The roller swage attachment can comprise a roller swage body having a spindle facing surface and a receiving channel extending through the spindle facing surface within the roller swage body and four post apertures in the spindle facing surface positioned equidistant from adjacent respective post apertures around the receiving channel. The roller swage attachment can also comprise four swage posts secured within respective post apertures of the four post apertures such that the four swage posts are positioned equidistant from adjacent respective swage post around the receiving channel and extend outward from the spindle facing surface of the roller swage body. Further, the roller swage apparatus can comprise four swage rollers corresponding to the four swage posts. Each of the four swage rollers can be secured on a corresponding swage post of the four swage posts such that the respective swage roller can be rotatable about the corresponding swage post. At least a portion of each swage roller can have a frustoconical shape with a smaller diameter portion of the swage roller being positioned proximate to an end of the respective swage post distal from the spindle facing surface of the roller swage body and a larger diameter portion of the swage roller proximate to a portion of the respective swage post that is proximal to the spindle facing surface of the roller swage body. Each swage roller can comprise a base that is cylindrical and has a diameter that is about equal to the larger diameter of the frustoconical shaped portion of the respective swage roller. The base of each swage roller can be tangential to an outer perimeter of the receiving channel.

Using a roller swage apparatus and an embodiment of a roller swage attachment as described above, a cylinder of material can be shaped to form a lug body with a barrel portion and a tongue portion with a transition portion between the barrel portion and the tongue portion. The method, or process can comprise securing a cylinder of material having an outer diameter and an inner diameter on the spindle and rotating the cylinder of material using the spindle. The tool post can be moved to move a roller swage attachment to a position such that the cylinder of material is aligned with a receiving channel in a roller swage body of the roller swage attachment and swage rollers are aligned with the outer diameter of the cylinder of material being treated. The roller swage attachment can then be moved toward the cylinder of material until the swage rollers engage the outer diameter of the cylinder of material. The cylinder of material can then be swaged with the swage rollers as the spindle spins the cylinder of material decreasing the outer diameter and inner diameter of a desired portion of the cylinder of material engaged by the swage rollers. At the same time, the swage rollers elongate the desired portion of the cylinder of material as the roller attachment is moved along the cylinder of material. Once the desired portion of the cylinder of material is swaged to form a lug body having a barrel portion, transition portion, and tongue portion of respective desired lengths, the roller swage attachment can be moved away from the cylinder of material such that the swage rollers disengage the cylinder of material. The controller of the roller swage apparatus can control the rotational speed of the spindle and the movement of the tool post and, in turn, the roller swage attachment such that the treatment of the cylinder of material provides a precisely formed lug body having a barrel portion, transition portion, and tongue portion of respective desired lengths.

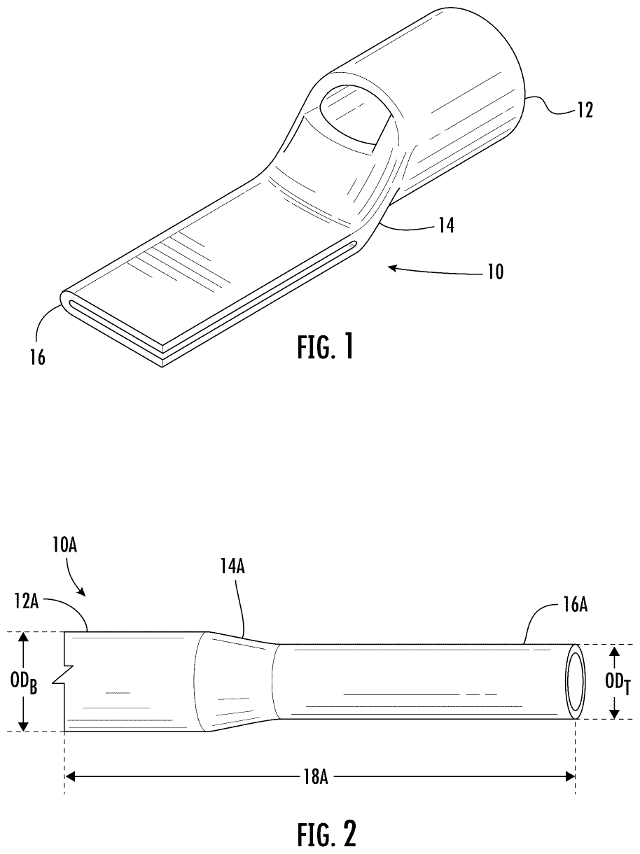

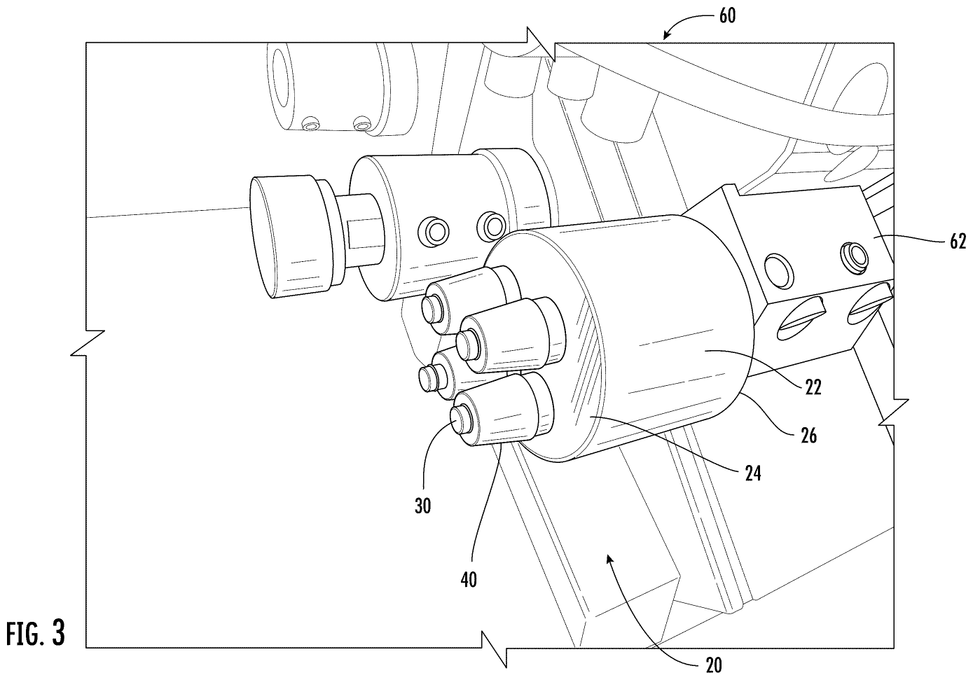

Referring to FIG. 1, a lug, generally 10, is provided that includes a barrel portion 12 and a flattened tongue portion 16. The lug 10 can have transition portion 14 that resides between the barrel portion 12 and the tongue portion 16. The barrel portion 12 can have a specified outer diameter and inner diameter that can meet a specification of use for the lug 10. As shown in FIG. 2, the lug 10 can be formed from a lug body, generally 10A. The lug body 10A can comprise a barrel portion 12A that has an outer diameter ODB and an inner diameter (not shown) that correspond to the specified outer diameter and inner diameter of the barrel portion 12 of the lug 10. Further, the lug body 10A can comprise a tongue portion 16A that has an outer diameter ODT and an inner diameter (not shown) that is smaller than the outer diameter ODB and inner diameter of the barrel portion 12A with a transition portion 14 between the barrel portion 12A and the tongue portion 16A. The lug body 10A can have an overall length 18A that, once the tongue portion 16A is flattened and the lug body 10A is formed into the lug 10, permits the lug 10 to have a desired length. To form the lug body 10A, a roller swage attachment and/or roller swage apparatus as disclosed herein can be used as described further below. The lug 10 and the lug body 10A can comprise a metal. For example, in some embodiments, the lug 10 and the lug body 10A can comprise copper, aluminum, copper alloy, aluminum alloy, or the like.

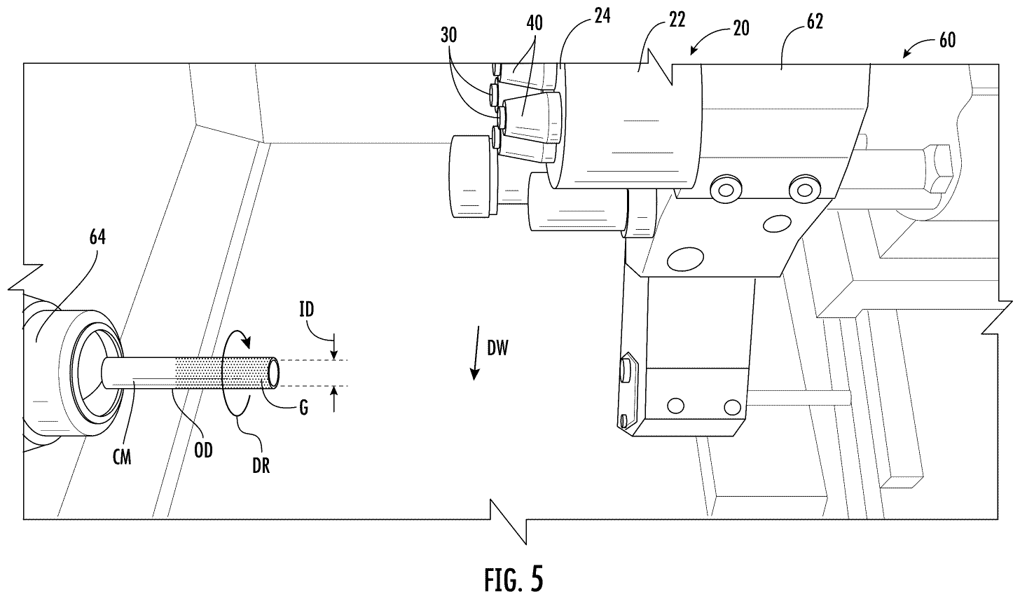

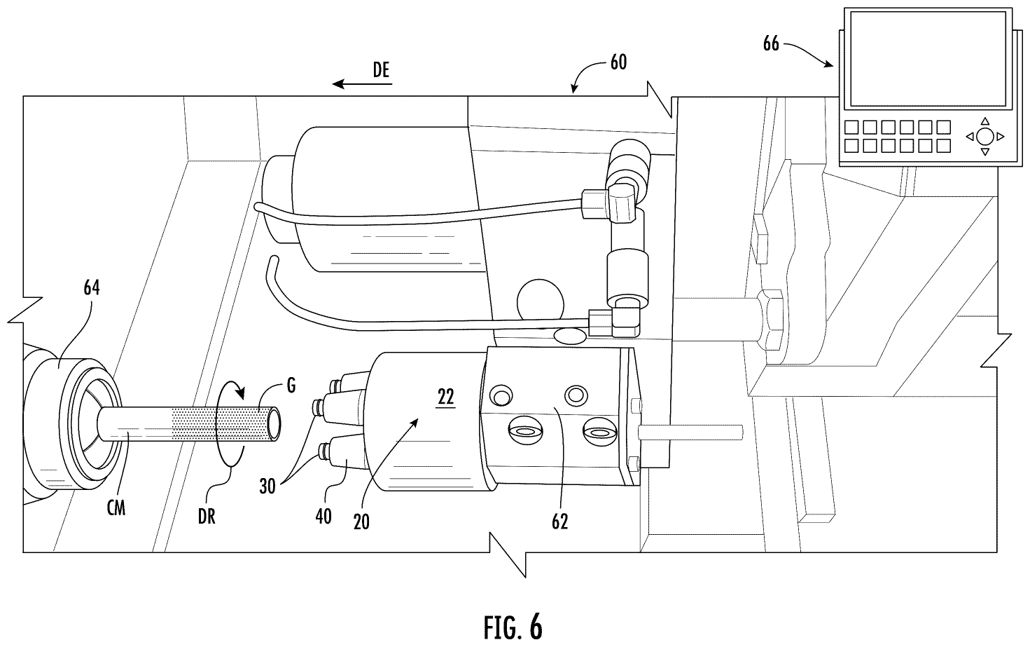

Referring to FIGS. 3 and 5, a roller swage apparatus, generally 60, for swaging a portion of a cylinder of material to form a lug body, such as lug body 10A, can be provided. The roller swage apparatus 60 can comprise a spindle 64 for holding and rotating a cylinder CM of material and a tool post 62 that is movable into and out of alignment with the spindle 64. As shown in FIGS. 6-8, the roller swage apparatus 60 can also comprise a controller 66 for operating the spindle 64 and the movement of the tool post 62. For example, the controller 66 can be any computing device that can be used to control the roller swage apparatus, such as a computing device used to operate a CNC machine, such as a CNC lathe machine. The computing device may be provisioned with a user interface and a hardware-based processor that is configured to execute software programs or applications. Additionally, the roller swage apparatus 60 can comprise a roller swage attachment 20 secured to the tool post 62 for engaging the cylinder CM of material to shape the cylinder CM of material into a lug body. For example, in some embodiments, the roller swage apparatus 60 can be a CNC lathe machine with the roller swage attachment 20 secured to the tool post 62 of the CNC lathe machine.

The roller swage attachment 20 can comprise a roller swage body 22 having a spindle facing surface 24 and a plurality of swage posts 30 extending from the spindle facing surface 24 of the roller swage body 22. Further, the roller swage attachment 20 can comprise a plurality of swage rollers 40 corresponding to the plurality of swage posts 30 with each of the plurality of the swage rollers 40 being secured on a corresponding swage post 30 of the plurality of swage posts 30 such that each respective swage roller 40 can rotate about the corresponding swage post 30 as needed.

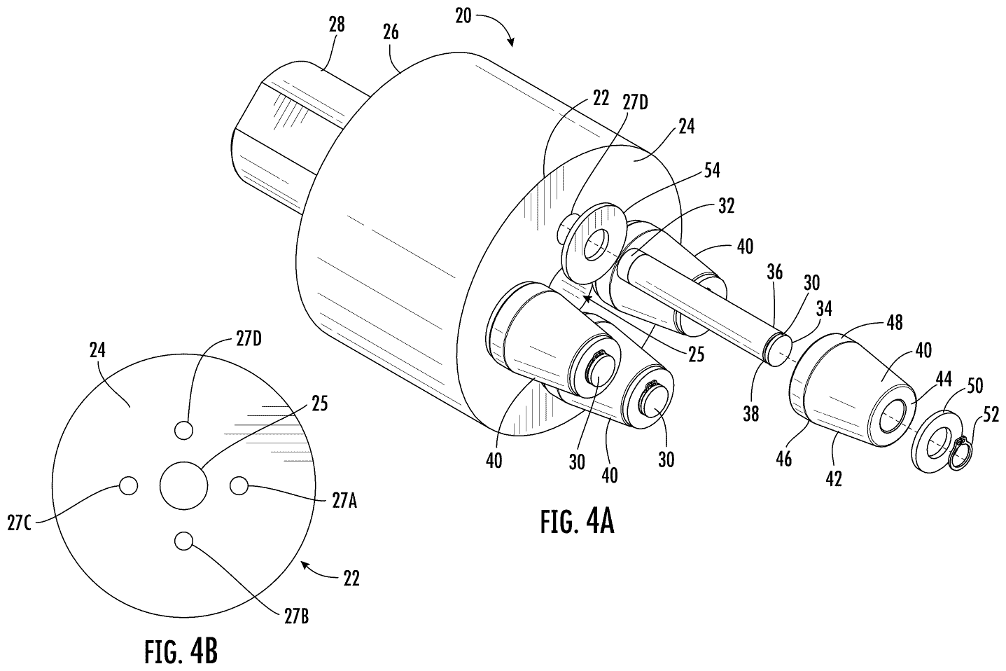

Referring to FIGS. 4A and 4B, an embodiment of a roller swage attachment 20 is shown. In the embodiment shown, the roller swage attachment 20 can comprise a roller swage body 22 having a spindle facing surface 24 and a receiving channel 25 extending through the spindle facing surface 24 within the roller swage body 22. For example, the receiving channel 25 can extend into a depth of the roller swage body 22 that is deep enough to receive the swaged end of the cylinder of material that is being treated. In some embodiments, the receiving channel 25 may extend through the roller swage body 22. Additionally, four post apertures 27A, 27B, 27C, 27D can reside in the spindle facing surface 24 of the roller swage body 22. The four post apertures 27A, 27B, 27C, 27D can be positioned equidistant from adjacent respective post apertures 27A, 27B, 27C, 27D around the receiving channel 25. Each of the four post apertures 27A, 27B, 27C, 27D can be about the same distance from the receiving channel 25.

The roller swage attachment 20 can also comprise four swage posts 30 secured within respective post apertures 27A, 27B, 27C, 27D such that the four swage posts 30 are positioned equidistant from adjacent respective swage posts 30 around the receiving channel 25. Each swage post 30 can have a base end 32 that can be secured in the respective post apertures 27A, 27B, 27C, 27D and a distal end 34. Each swage post 30 can also have a cylindrical surface 36 and a retention groove 38. As with the four post apertures 27A, 27B, 27C, 27D, each of the four swage posts 30 can be about the same distance from the receiving channel 25. The four swage posts 30 can extend outward from the spindle facing surface 24 of the roller swage body 22.

Additionally, the roller swage attachment 20 can comprise four swage rollers 40 corresponding to the four swage posts 30. Each of the four swage rollers 40 can be secured on a corresponding swage post 30 of the four swage posts 30 about the cylindrical surface 36 of the swage post 30 such that the respective swage roller 40 can be rotatable about the cylindrical surface 36 of the corresponding swage post 30. As shown in FIG. 4A, at least a portion of each swage roller 40 can have a frustoconical shape 42 with a smaller diameter portion 44 of the swage roller 40 being positioned proximate to an end 34 of the respective swage post 30 distal from the spindle facing surface 24 of the roller swage body 22 and a larger diameter portion 46 of the swage roller 40 proximate to a portion 32 of the respective swage post 40 that is proximal to the spindle facing surface 24 of the roller swage body 22. Each swage roller 40 can comprise a base 48 that is cylindrical and has an outer diameter that is about equal to the larger diameter portion 46 of the frustoconical shaped portion 42 of the respective swage roller. In some embodiments, the base 48 of each swage roller 40 can be about tangential to an outer perimeter of the receiving channel 25. In some embodiments, the base 48 of each swage roller 40 can overhang the outer perimeter of the receiving channel 25.

In this manner when the roller swage attachment 20 is used, a rotating cylinder CM of material (see FIG. 5) to be treated can be spun about an axis of the cylinder CM and aligned with the receiving channel 25. The cylinder CM can then be moved toward the receiving channel 25 of the roller swage body 20 and the swage rollers 40 can contact a portion of an outer diameter OD of the rotating cylinder CM of material as the cylinder CM is rotated causing the portion of the outer diameter OD to be contacted by the plurality of swage rollers 40 under force. The shape of swage rollers 40 can swage the cylinder CM of material to form the shape of a lug body with reduced heat-affected stresses on the cylinder CM of material and the tooling, such as the swage rollers 40 and roller swage attachment 20, and reduced spindle loads. With the shape of the swage rollers 40 and the position of the base 48 of the swage rollers 40, the cylinder CM of material can be swaged to form the tongue portion of the lug body with a reduced outer diameter and inner diameter that can be fed into the receiving channel 25 as the swage rollers 40 move up the cylinder CM of material.

To facilitate the rotatability of the swage rollers 40, the roller swage attachment 20 can also comprise a plurality of end washers 50 and base washers 54. Each base washer 54 can be positioned on a respective swage post of the plurality of swage posts 30 between the spindle facing surface 24 of the roller swage body 22 and the respective swage roller 40 adjacent the base 48 of the respective swage roller 40. Each end washer 50 can be positioned on the respective swage post 30 adjacent the end of the respective swage roller 40 with the small diameter portion 44 distal from the spindle facing surface 24 of the roller swage body 22. Further, the roller swage attachment 20 can comprise a plurality of retaining rings 52. Each retaining ring 52 can be secured to the respective swage post 30, for example within the retention groove 38 of the respective swage post 30, adjacent to the respective end washer that is adjacent to the respective swage roller. Each retaining ring 52 can thereby secure the respective swage roller 40 to the respective swage post 30 such that the respective swage roller 40 is rotatable about the respective swage post 30.

Additionally, the roller swage body 22 can have a side 26 opposite the spindle facing surface 24 as shown in FIGS. 3 and 4A. The roller swage body 22 can comprise a rear tail mount 28 positioned on the opposite side 26. The rear tail mount 28 can be configured to engage a tool post 62 (see FIG. 3). In this manner, the rear tail mount 28 can secure the roller swage body 22 to the tool post 62 of the roller swage apparatus 60 for positioning the roller swage body 22 in front of the spindle 64 of the roller swage apparatus 60 when the tool post 62 and the roller swage attachment 20 are moved into proper position.

To facilitate the swaging of the cylinder CM of material and prevent damage to the roller swage attachment 20, the swage rollers 40 can comprise a metal that has a hardness that is greater than the hardness of the cylinder CM of material to be treated. Additionally, the roller swage body 22 can also comprise a metal that has a hardness that is greater than the hardness of the cylinder CM of material to be treated. For example, the swage rollers 40 of the roller swage body 22 can comprise a metal such as steel, stainless steel, or the like.

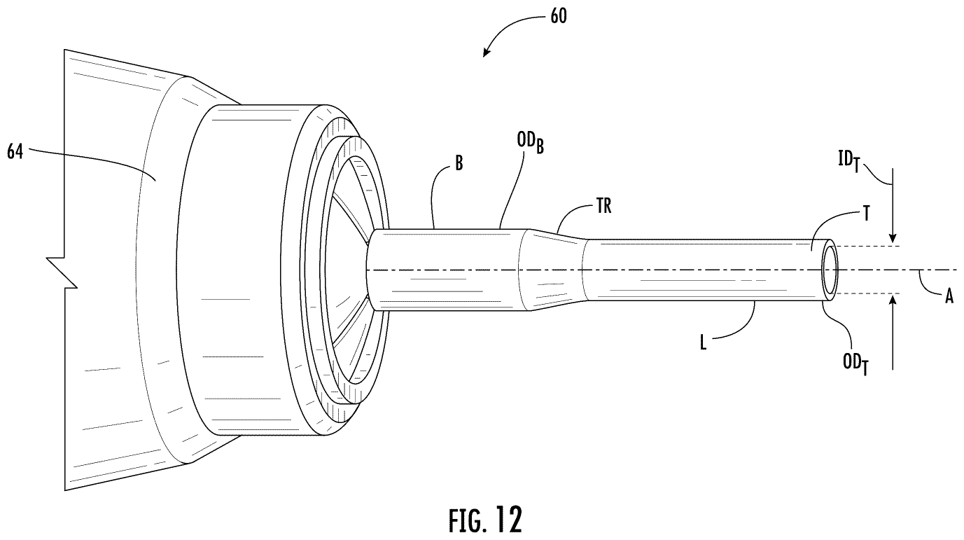

Referring to FIGS. 5-12, a roller swage apparatus 60 and an embodiment of a roller swage attachment 20, as described above, can be used to shape a cylinder CM of material to form a lug body L with a barrel portion B and a tongue portion T with a transition portion TR between the barrel portion B and the tongue portion T. The method, or process, can comprise securing a cylinder CM of material having an outer diameter OD and an inner diameter ID on the spindle 64 and rotating the cylinder CM of material, for example, in a direction of rotation DR using the spindle 64 as shown in FIG. 5. The spindle 64 rotates the cylinder CM of material about its axis A as shown in FIG. 12. For example, the cylinder CM of material can be inserted into an opening in the spindle 64. The cylinder CM of material can be lubricated with a lubricant G (shown as the spaced apart dots on the cylinder CM) to reduce friction to reduce the amount of heat created during swaging. For example, the roller swage apparatus 60 can have a lubricating mechanism (not identified) to add lubricant G during the swaging process. The roller swage attachment 20 can be secured to the tool post 62 so that the roller swage body 22 resides against the tool post 62 with the spindle facing surface 24 of the roller swage body 22 facing the spindle 64 with the swage post 30 and the swage rollers 40 thereon extending out from the spindle facing surface 24.

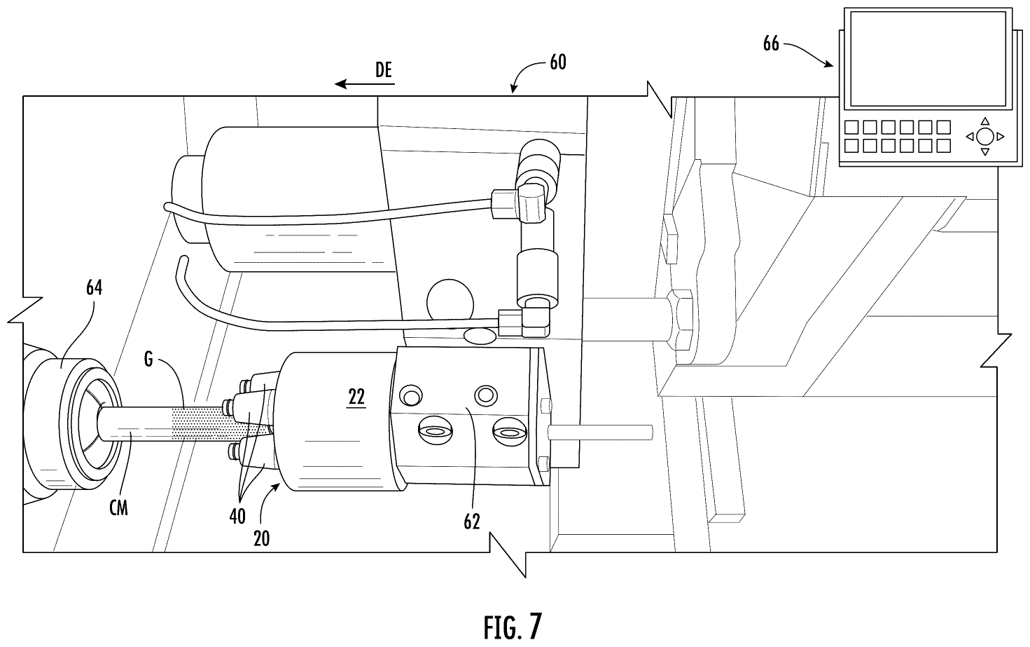

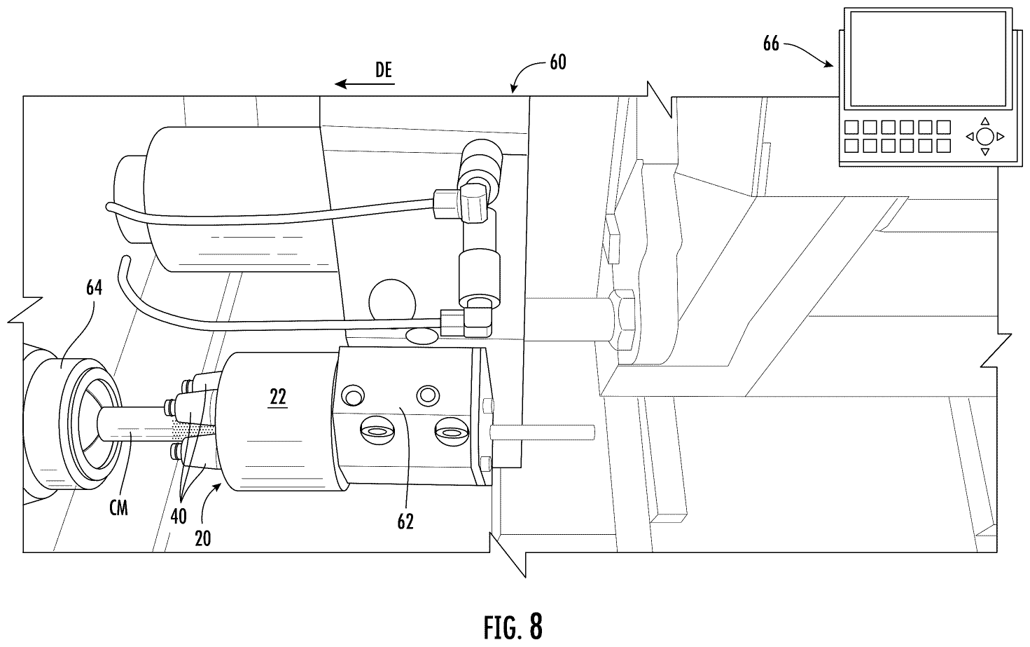

To begin, as shown in FIG. 5, the tool post 64 of the roller swage apparatus 60 can be in an idle position that is unaligned with the spindle 64. The tool post 62 can be moved in a direction DW as shown in FIG. 5 to move the roller swage attachment 20 to a position such that the cylinder CM of material is aligned with the receiving channel 25 (see FIG. 4A) in the roller swage body 22 of the roller swage attachment 20 and swage rollers 40 are aligned with the outer diameter OD of the cylinder CM of material being treated as shown in FIG. 6. The roller swage attachment 20 can then be moved toward the cylinder CM of material with the tool post 62 until the swage rollers 40 engage the outer diameter OD of the cylinder CM of material as shown in FIGS. 7 and 8. The swage rollers 40 are free to rotate as needed during the swaging to reduce friction. The cylinder CM of material can then be swaged with the swage rollers 40 as the spindle spins the cylinder CM of material in direction DR. The force created by the movement of the tool post 62 in the direction DE by the roller swage apparatus 60 causes the swage rollers to swage the cylinder CM of material decreasing the outer diameter OD and inner diameter ID of a desired portion of the cylinder CM of material that is engaged by the swage rollers 40. At the same time, the swage rollers 40 elongate the desired portion of the cylinder of material as the roller swage attachment 20 is moved along the cylinder CM of material with end portions of the swaged portion of the cylinder CM of material entering the receiving channel in the roller swage body 22. The shape of the swage rollers 40 and their position relative to one another help to ensure the tongue portion T that has been swaged obtains the desired length, outer diameter ODT, and inner diameter IDT as shown in FIG. 12, while also reducing stress and heat in the cylinder CM of material and the roller swage attachment 20. The shape of the swage rollers 40 can also ensure a desired angle of the transition portion TR of the lug body L.

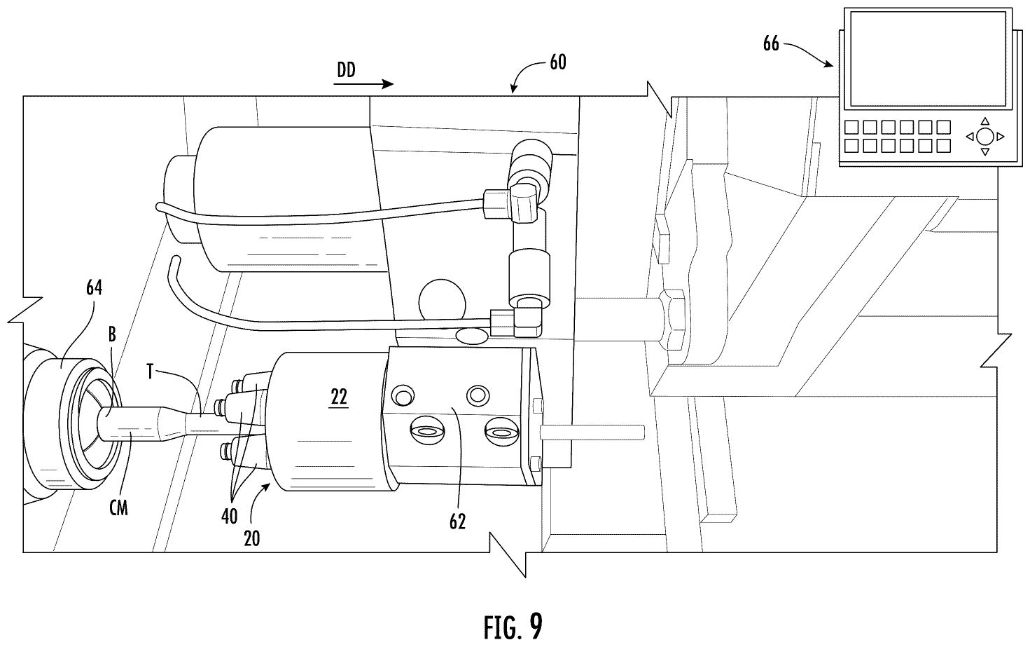

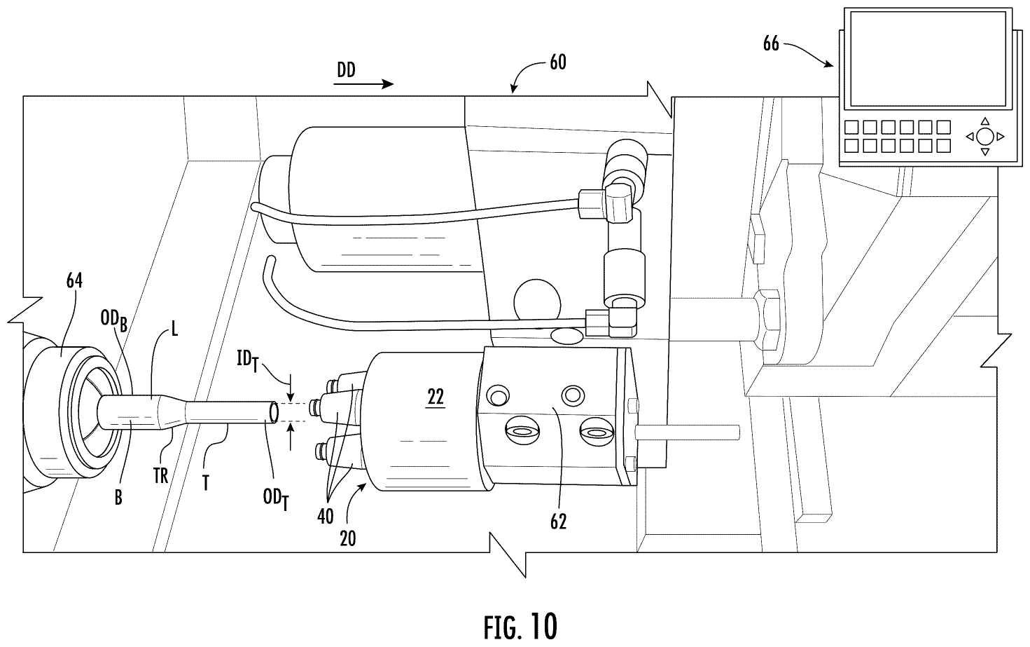

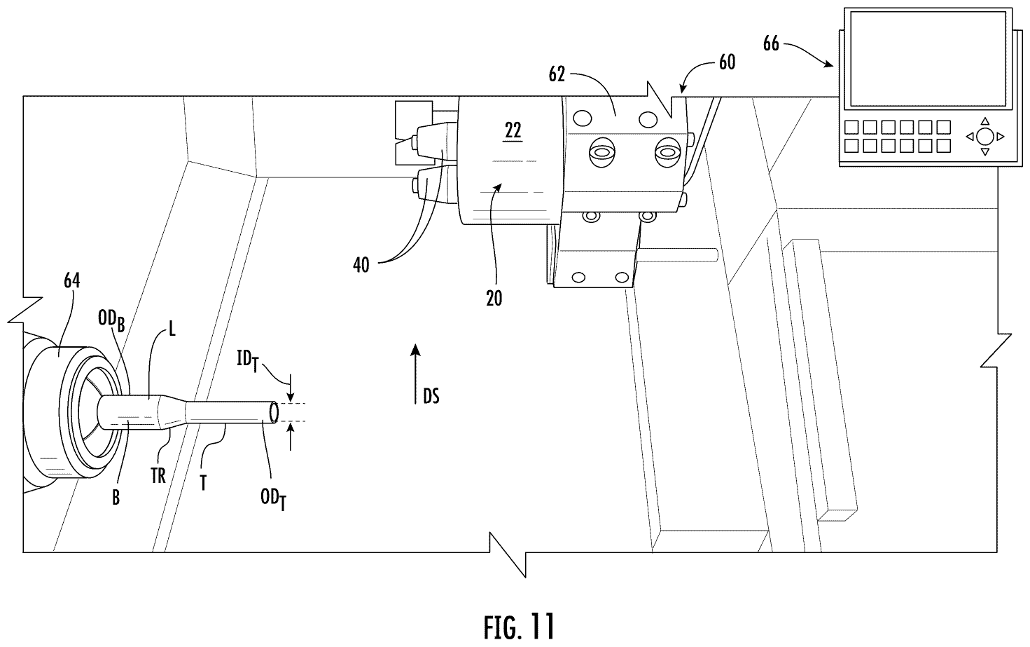

Once the desired portion of the cylinder CM of material is swaged to form a lug body L having a barrel portion B, transition portion TR, and tongue portion T of respective desired lengths and the barrel portion B retains its desired outer diameter ODB and the tongue portion possesses a desired outer diameter ODT, the roller swage attachment 20 can be moved in a direction DD away from the cylinder CM of material such that the swage rollers 40 disengage the cylinder CM of material as shown in FIGS. 9 and 10. As shown in FIG. 11, once the roller swage attachment 20 is pulled away from the cylinder CM of material and the lug body L is formed, the tool post 62 can be moved in a direction DS traverse to the spindle 64 such that roller swage attachment 20 is out of the alignment with the cylinder CM of material back to the idle position. The idle position of the tool post 62 and the roller swage attachment 20 can provide more space and increase access to the swaged cylinder CM of material, i.e., the newly formed lug body L.

As stated above, the controller 66 of the roller swage apparatus can control the rotational speed of the spindle 64 and the movement of the tool post 62 and, in turn, the roller swage attachment 20, such that the treatment of the cylinder CM of material provides a precisely formed lug body L having a barrel portion B, transition portion TR, and tongue portion T of respective desired lengths.

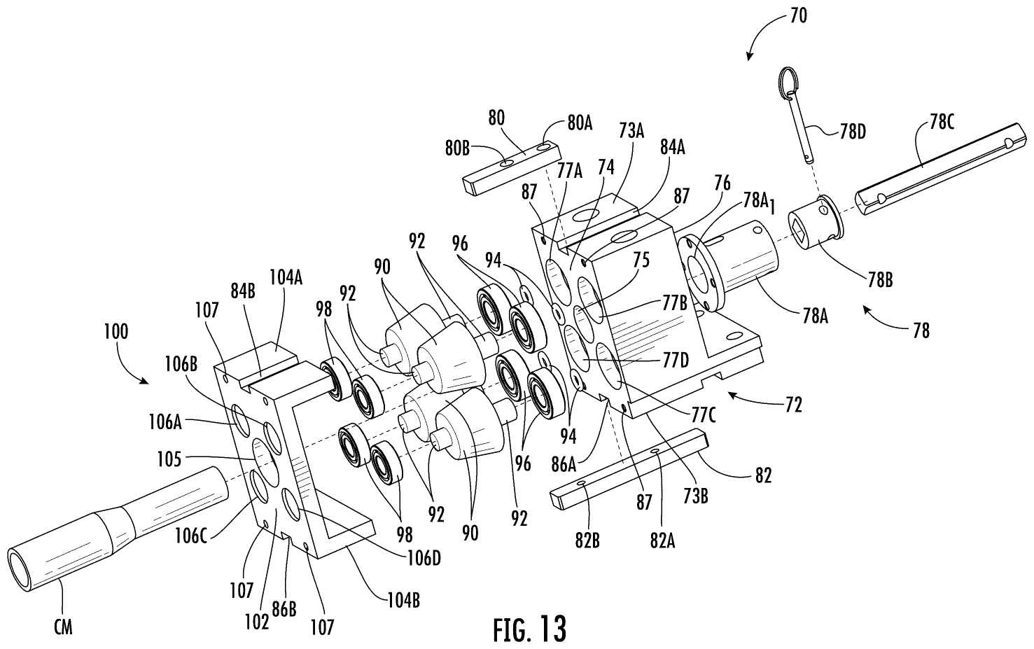

Referring to FIG. 13, another embodiment of a roller swage attachment 70 is provided that is shown in an exploded view. The roller swage attachment 70 can comprise a roller swage body 72 having a spindle facing surface 74 and a plurality of swage rollers 90 that are rotatably securable to the roller swage body 72 so that the plurality of swage rollers 90 extend from the spindle facing surface 74 of the roller swage body 72. Further, each of the plurality of swage rollers 90 can have a swage post 92 extending therefrom. Unlike some other embodiments, the intend of the embodiment shown in FIG. 13 is to fixedly secure each swage roller 90 to its corresponding swage post 92 so that both the swage roller 90 and the post 92 posts rotate together as the spinning cylindrical material rotates the swage roller 90 during the swaging process. In some embodiments, the swage post 92 for each of the swage rollers 90 can be a post that extends through the swage roller 90. In some embodiments, the swage post 92 can be an integral part of the respective swage roller 90. For example, a top post portion and a bottom post portion can be formed on either side of a frustoconical body of each of the swage roller 90 to form the respective swage post 92 above and below the frustoconical body of the respective swage roller 90. The angle of the frustoconical shape as measure from the small diameter can vary. In some embodiments, the angle can be about 8° and about 15°. The bottom portion of the posts 92 can be inserted into base end ball bearings 96 that are in turn inserted into the roller swage body 72, as explained below, so that the posts 92 and the swage rollers 90 rotate together. This arrangement can help increase the life of the roller swage attachment 70 by reducing wear on the posts and allow preplacement of the base end ball bearings 96, which can be more cost effective.

As described above in other embodiments, the roller swage body 22 can have a receiving channel 75 extending through the spindle facing surface 74 within the roller swage body 72. Additionally, four post apertures 77A, 77B, 77C, 77D can reside in the spindle facing surface 74. The four post apertures 77A, 77B, 77C, 77D can be positioned equidistant from adjacent respective post apertures 77A, 77B, 77C, 77D around the receiving channel 75. Each of the four post apertures 77A, 77B, 77C, 77D can be about the same distance from the receiving channel 75. Unlike previous post apertures described above, the four post apertures 77A, 77B, 77C, 77D have a wider diameter configured to hold an outer ring of the respective ball bearing 96 placed in each post aperture 77A, 77B, 77C, 77D. When positioned in the post apertures 77A, 77B, 77C, 77D, the swage posts 92 and the swage rollers 90 extend outward from the spindle facing surface 74 of the spindle body 72.

As stated above, each of the base end ball bearings 96 can be positioned on a respective swage post 92. For example, a bottom portion of each of the swage posts 92 can be inserted into the inner ring that forms the inner race of the corresponding ball bearing 96 such that the inner ring of the corresponding ball bearing 96 rotates with the swage post 92 as the swage post rotates with the corresponding swage roller 90. Each of the base end ball bearings 96 can then be inserted into a respective post aperture 77A, 77B, 77C, 77D of the plurality of post apertures 77A, 77B, 77C, 77D such that each swage post 92 is rotatable. Additionally, a high-load thrust bearing 94 can be placed in each of the post apertures 77A, 77B, 77C, 77D such that the swage posts 92 contact the when the swage posts 92 and the base end ball bearings 96 are installed in the post apertures 77A, 77B, 77C, 77D. The high-load thrust bearing 94 can be a low friction thrust bearing that protects the swage posts 92 and the post apertures 77A, 77B, 77C, 77D. Incorporating the swage posts 92 into the swage rollers 90 and using the base end ball bearings 96 as described above can aid in handling the large loads placed on the swage rollers 90 and swage post 92 to help increase the life of the roller swage attachment 70.

As shown in FIG. 13, the roller swage attachment 70 can also include an end cap 100 that can be secured to the roller swage body 72 to support the top end portions of the swage posts 92 to help keep the swage rollers 90 and swage post 92 from spreading apart during the swaging of material. Similar to the roller swage body 72, the end cap 100 can have an outer surface, or spindle facing surface, 102 and a receiving channel 105 extending therethrough for receiving the material being swaged during operation. Additionally, the end cap 100 can have a plurality of cap post apertures 106A, 106B, 106C, 106D positioned around the receiving channel 105 which corresponds to the number of swage posts 92. Each of cap post apertures 106A, 106B, 106C, 106D is configured to receive a top end portion of a corresponding swage post 92 of the plurality of the swage posts 92. In particular, the swage body attachment 70 can also comprise a plurality of top end ball bearings 98 for securing to the top end portions of the swage posts 92 and then insertion into the cap post apertures 106A, 106B, 106C, 106D of the end cap 100 when the end cap 100 is used. Each top end ball bearing 98 can be positioned on a top portion of a respective swage post 92 of the plurality of swage posts 92. Each top end ball bearing 98 can then be inserted into a respective cap post aperture 106A, 106B, 106C, 106D of the plurality of cap post apertures 106A, 106B, 106C, 106D to hold the top end portions of the swage posts 92 while allowing each swage post 92 to rotate. For example, a top end portion of each of the swage posts 92 can be inserted into the inner ring that forms the inner race of the corresponding top end ball bearing 98 such that the inner ring of the corresponding top end ball bearing 98 rotates with the swage post 92 as the swage post 92 rotates with the corresponding swage roller 90.

In some embodiments, the roller swage attachment 70 can also comprise a mandrel 78C that can be inserted into the receiving channel 75 and around a tubular cylinder of material that is being swaged can fit. The mandrel 78C can be used to maintain an inner diameter of a cylinder of material as the cylinder of material is swaged by the swage rollers 90. In some embodiments, a mandrel attachment 78 can be used to secure the mandrel 78C to the roller swage attachment 70. The mandrel attachment 78 can comprise a swage inner diameter guide holder 78A having an inner diameter 78A1. The swage inner diameter guide holder 78A can be secured to a side 76 opposite the spindle facing surface 74 of the roller swage attachment 70. The mandrel attachment 78 can also comprise a swage inner diameter guide bushing 78B. The swage inner diameter guide bushing 78B is configured to fit into the inner diameter 78A1 of the swage inner diameter guide holder 78A. The swage inner diameter guide bushing 78B can have a mandrel aperture therein that is configured to receive the mandrel 78C. The mandrel 78C and the mandrel aperture can be shaped to aid in the prevention of the rotation of the mandrel 78C in the swage inner diameter guide bushing 78B during operation of the roller swage attachment 70. Additionally, the mandrel attachment 78 can comprise a locking pin 78D that is insertable through locking apertures in the swage inner diameter guide holder 78A, swage inner diameter guide bushing 78B and the mandrel 78C to also help hold the mandrel 78C in place during operation. The mandrel 78C can be shaped and can be held in the swage inner diameter guide bushing 78B such that outer edges of the mandrel 78C align with the base portions of the swage rollers 90.

The end cap 100 can be secured to roller swage body 72. For example, the end cap 100 can be secured by fasteners to secure the end cap 100 to the roller swage body 72. For example, both the end cap 100 and the roller swage body 72 can have fastening apertures 107, 87 respectively therein for accepting fasteners that hold the end cap 100 to the roller swage body 72. In some embodiments, fastening apertures 87 in the roller swage body 72 can be screw apertures located in the spindle facing surface 74 close to the corners of the roller swage body 72. Similarly, fastening apertures 107 in the end cap 100 can also be screw apertures located in the spindle facing surface 102 that extend through the end cap 100 such that the fastening apertures 107 are aligned with the fastening apertures 87 in the roller swage body 72 for attaching the end cap 100 to the roller swage body 72 so that caps screws (not shown) can be fastened into the aligned fastening apertures 107, 87 to secure the end cap 100 to the roller swage body 72.

Additionally, in some embodiments, as shown in FIG. 13, locking keys 80 and 82 can be used to help hold the end cap 100 steadfastly to roller swage body 72 by providing strength at the union of the end cap 100 and the roller swage body 72 to help resist the torque placed on the end cap 100 and roller swage body 72 by the swaging operation. For example, in some embodiments, the swage roller body 72 can have a top key channel 84A in a top side 73A of the swage roller body 72 and the end cap 100 can have a top key channel 84B in a top side 104A of the end cap 100. Similarly, the roller swage body 72 can have a bottom key channel 86A in a bottom side 73B of the swage roller body 72 and the end cap 100 can have a bottom key channel 86B in a bottom side 104B of the end cap 100. The top key channel 84A in the roller swage body 72 and top key channel 84B in the end cap 100 can be aligned to form a key channel in which the top locking key 80 can be place such that the top locking key 80 bridges the end cap 100 and the roller swage body 72 along a top side of the roller swage attachment 70. The top locking key 80 can have locking apertures 80A, 80B that are alignable with locking apertures (not shown) in the key channel 84A of the roller swage body 72. Once aligned, fasteners can be inserted in the locking apertures 80A, 80B of the top locking key 80 to secure the locking key 80 to the roller swage body 72. Similarly, the bottom key channel 86A in the roller swage body 72 and bottom key channel 86B in the end cap 100 can be aligned to form a key channel in which the bottom locking key 82 can be place such that the bottom locking key 82 bridges the end cap 100 and the roller swage body 72 along a bottom side of the roller swage attachment 70. The bottom locking key 82 can have locking apertures 82A, 82B that are alignable with locking apertures (not shown) in the bottom key channel 86A of the roller swage body 72 and/or the bottom key channel 86B of the roller end cap 100. Once aligned, fasteners can be inserted in the locking apertures 82A, 82B of the bottom locking key 82 to secure the locking key 82 to the roller swage body 72 and/or the end cap 100. With the locking keys 80, 82 bridging the end cap 100 and the roller swage body 72 on both the top and bottom sides of the roller swage attachment 70, the locking keys 80, 82 help resist the torque placed on the end cap 100 and roller swage body 72 by the swaging operation.

In some other embodiments, the top locking key 80 can have a locking aperture that is alignable with a locking aperture (not shown) in the key channel 84A of the roller swage body 72 and a locking aperture that is alignable with a locking aperture (not shown) in the key channel 84B of the end cap 100 on the top side of the roller swage attachment 70. Once aligned, fasteners can be inserted in the locking apertures to secure the locking key 80 to both the roller swage body 72 and the end cap 100. Similarly, the bottom locking key 82 can have a locking aperture that is alignable with a locking aperture (not shown) in the bottom key channel 86A of the roller swage body 72 and a locking aperture that is alignable with a locking aperture (not shown) in the bottom key channel 86B of the end cap 100. Once aligned, fasteners can be inserted in the locking apertures of the bottom locking key 82 to secure the locking key 82 to both the roller swage body 72 and the end cap 100 on the top side of the roller swage attachment 70.

Thus, with the top locking key 80 secured in place bridging the roller swage body 72 and the end cap 100 along a top portion of the roller swage attachment 70 and the bottom locking key 82 secured in place bridging the roller swage body 72 and the end cap 100 along an opposing bottom portion of the roller swage attachment 70, the end cap 100 and the roller swage body 72 are held more securely together with added strength to withstand the torque placed on the roller swage attachment 70 by the swaging operation during use.

In the foregoing specification, specific examples, features, and aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques, and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

1. A roller swage attachment for securing to a roller swage apparatus, the roller swage attachment comprising:
a roller swage body having a spindle facing surface and a receiving channel extending through the spindle facing surface within the roller swage body; and
a plurality of swage rollers extending from the spindle facing surface of the roller swage body with the plurality of swage rollers being rotatable relative to the roller swage body, each of the plurality of swage rollers positioned about the receiving channel such that, when a rotating cylinder of material to be treated is spun about an axis of the cylinder of material, aligned with the receiving channel and then moved toward the receiving channel of the roller swage body, the plurality of swage rollers contact a portion of an outer diameter of the rotating cylinder of material as the cylinder of material is rotated causing the portion of the outer diameter contacted by the plurality of swage rollers to be reduced.

2. The roller swage attachment according to claim 1, wherein at least a portion of each swage roller of the plurality of swage rollers has a frustoconical shape with a smaller diameter portion of the swage roller being positioned proximate to an end of the respective swage roller distal from the spindle facing surface of the roller swage body and a larger diameter portion of the swage roller proximate to the spindle facing surface of the roller swage body.

3. The roller swage attachment according to claim 2, wherein each swage roller of the plurality of swage rollers has a base that is cylindrical and has a diameter that is about equal to the larger diameter portion of the frustoconical shaped portion of the respective swage roller.

4. The roller swage attachment according to claim 3, wherein the base of each swage roller of the plurality of swage rollers is about tangential to an outer perimeter of the receiving channel.

5. The roller swage attachment according to claim 1, wherein a plurality of swage posts extending from the spindle facing surface of the roller swage body, each swage post located in a different position around the receiving channel; and
each of the plurality of swage rollers being secured on a corresponding swage post of the plurality of swage posts.

6. The roller swage attachment according to claim 5, wherein each of the plurality of swage rollers is rotatable about the corresponding swage post.

7. The roller swage attachment according to claim 6, wherein the plurality of swage posts comprise four swage posts positioned equidistant from adjacent respective swage post such that the respective swage rollers of the plurality of swage rollers are positioned on four sides of the receiving channel.

8. The roller swage attachment according to claim 7, further comprising a plurality of end washers, each end washer of the plurality of end washers positioned on the respective swage post adjacent a smaller diameter portion of each swage roller of the plurality of swage rollers.

9. The roller swage attachment according to claim 8, further comprising a plurality of retaining rings, each retaining ring of the plurality of retaining rings secured to the respective swage post adjacent to the respective end washer that is adjacent to the respective swage roller securing the respective swage roller to the respective swage post such that the respective swage roller is rotatable about the respective swage post.

10. The roller swage attachment according to claim 6, further comprising a plurality of base washers, each base washer positioned on a respective swage post of the plurality of swage posts between the spindle facing surface of the roller swage body and the respective swage roller of the plurality of swage rollers.

11. The roller swage attachment according to claim 5, wherein the roller swage body comprises a plurality of post apertures in the spindle facing surface positioned around the receiving channel in which the swage posts are secured such that the plurality of swage posts extends outward from the spindle facing surface.

12. The roller swage attachment according to claim 11, further comprising a plurality of base end ball bearings, each base end ball bearing positioned on a respective swage post of the plurality of swage posts and insertable into a respective post aperture of the plurality of post apertures such that each swage post of the plurality of swage post is rotatable.

13. The roller swage attachment according to claim 12, wherein each of the plurality of swage rollers are fixedly secured to the respective swage post of the plurality of swage posts such that the swage roller rotates as the respective swage post.

14. The roller swage attachment according to claim 11, further comprising an end cap for securing to the roller swage body, the end cap having a receiving channel extending therethrough and a plurality of cap post apertures positioned around the receiving channel in which a top portion of a corresponding swage post of the plurality of the swage posts are insertable.

15. The roller swage attachment according to claim 14, further comprising a plurality of top end ball bearings, each top end ball bearing positioned on a top portion of a respective swage post of the plurality of swage posts and insertable into a respective cap post aperture of the plurality of cap post apertures to hold the top portions of the plurality of swage posts while allowing each swage post of the plurality of swage post to rotate.

16. The roller swage attachment according to claim 1, further comprising a mandrel insertable into the receiving channel to maintain an inner diameter of a cylinder of material as the cylinder of material is swaged by the swage rollers.

17. The roller swage attachment according to claim 1, wherein the roller swage body comprises a rear tail mount positioned on a side opposite the spindle facing surface for securing the roller swage body to a tool post for positioning the roller swage body in front a spindle.

18. The roller swage attachment according to claim 1, wherein the plurality of swage rollers comprises a metal that has a hardness that is greater than the hardness of the cylinder of material to be treated.

19. A roller swage apparatus for swaging a portion of a cylinder of material to form a lug body, the roller swage apparatus comprising:
a spindle for holding and rotating a cylinder of material;
a tool post that is movable into and out of alignment with the spindle;
a controller for operating the spindle and movement of the tool post; and
a roller swage attachment secured to the tool post for engaging the cylinder of material to shape the cylinder of material, the roller swage attachment comprising:
a roller swage body having a spindle facing surface and a receiving channel extending through the spindle facing surface within the roller swage body; and
a plurality of swage rollers extending from the spindle facing surface of the roller swage body with the plurality of swage rollers being rotatable relative to the roller swage body, each of the plurality of swage rollers positioned about the receiving channel such that, when a rotating cylinder of material to be treated is spun about an axis of the cylinder of material, aligned with the receiving channel and then moved toward the receiving channel of the roller swage body, the plurality of swage rollers contact a portion of an outer diameter of the rotating cylinder of material as the cylinder of material is rotated causing the portion of the outer diameter contacted by the plurality of swage rollers to be reduced.

20. The roller swage apparatus according to claim 19, wherein at least a portion of each swage roller of the plurality of swage rollers has a frustoconical shape with a smaller diameter portion of the swage roller being positioned proximate to an end of the respective swage post distal from the spindle facing surface of the roller swage body and a larger diameter portion of the swage roller proximate to a portion of the respective swage post that is proximal to the spindle facing surface of the roller swage body.

21. The roller swage apparatus according to claim 20, wherein each swage roller of the plurality of swage rollers has a base that is cylindrical and has a diameter that is about equal to the larger diameter portion of the frustoconical shaped portion of the respective swage roller.

22. The roller swage apparatus according to claim 21, wherein the base of each swage roller of the plurality of swage rollers is tangential to an outer perimeter of the receiving channel.

23. The roller swage apparatus according to claim 22, wherein the plurality of swage posts comprise four swage posts positioned equidistant from adjacent respective swage post such that the respective swage rollers of the plurality of swage rollers are positioned on four sides of the receiving channel.

24. The roller swage apparatus according to claim 19, wherein a plurality of swage posts extending from the spindle facing surface of the roller swage body, each swage post located in a different position around the receiving channel; and
each of the plurality of swage rollers being secured on a corresponding swage post of the plurality of swage posts.

25. The roller swage apparatus according to claim 24, wherein each of the plurality of swage rollers is rotatable about the corresponding swage post.

26. The roller swage apparatus according to claim 25, further comprising a plurality of end washers, each end washer of the plurality of end washers positioned on the respective swage post adjacent a smaller diameter portion of each swage roller of the plurality of swage rollers.

27. The roller swage apparatus according to claim 26, further comprising a plurality of retaining rings, each retaining ring of the plurality of retaining rings secured to the respective swage post adjacent to the respective end washer that is adjacent to the respective swage roller securing the respective swage roller to the respective swage post such that the respective swage roller is rotatable about the respective swage post.

28. The roller swage apparatus according to claim 25, further comprising a plurality of base washers, each base washer positioned on a respective swage post of the plurality of swage posts between the spindle facing surface of the roller swage body and the respective swage roller of the plurality of swage rollers.

29. The roller swage apparatus according to claim 24, wherein the roller swage body comprises a plurality of post apertures in the spindle facing surface positioned around the receiving channel in which the swage posts are secured such that the plurality of swage posts extends outward from the spindle facing surface.

30. The roller swage apparatus according to claim 29, further comprising a plurality of base end ball bearings, each base end ball bearing positioned on a respective swage post of the plurality of swage posts and insertable into a respective post aperture of the plurality of post apertures such that each swage post of the plurality of swage post is rotatable.

31. The roller swage apparatus according to claim 30, wherein each of the plurality of swage rollers are fixedly secured to the respective swage post of the plurality of swage posts such that the swage roller rotates as the respective swage post.

32. The roller swage apparatus according to claim 29, further comprising an end cap for securing to the roller swage body, the end cap having a receiving channel extending therethrough and a plurality of cap post apertures positioned around the receiving channel in which a top portion of a corresponding swage post of the plurality of the swage posts are insertable.

33. The roller swage apparatus according to claim 32, further comprising a plurality of top end ball bearings, each top end ball bearing positioned on a top portion of a respective swage post of the plurality of swage posts and insertable into a respective cap post aperture of the plurality of cap post apertures to hold the top portions of the plurality of swage posts while allowing each swage post of the plurality of swage post to rotate.

34. The roller swage apparatus according to claim 19, wherein the roller swage body comprises a rear tail mount positioned on a side opposite the spindle facing surface for securing the roller swage body to a tool post for positioning the roller swage body in front a spindle.

35. The roller swage apparatus according to claim 19, wherein the roller swage body comprises a plurality of post apertures in the spindle facing surface positioned around the receiving channel in which the plurality of swage posts are secured such that the plurality of swage posts extend outward from the spindle facing surface.

36. The roller swage apparatus according to claim 19, further comprising a mandrel insertable into the receiving channel to maintain an inner diameter of a cylinder of material as the cylinder of material is swaged by the swage rollers.

37. A method of swaging a cylinder of material to shape the cylinder of material for forming a lug body, the method comprising steps of:
providing a roller swage apparatus comprising:
a spindle for holding and rotating a cylinder of material;
a tool post that is movable into and out of alignment with the spindle;
a controller for operating the spindle and movement of the tool post; and
a roller swage attachment secured to the tool post for engaging the cylinder of material to shape the cylinder of material, the roller swage attachment comprising:
a roller swage body having a spindle facing surface and a receiving channel extending through the spindle facing surface within the roller swage body; and a plurality of swage rollers extending from the spindle facing surface of the roller swage body with the plurality of swage rollers being rotatable relative to the roller swage body, each of the plurality of swage rollers positioned about the receiving channel;
securing a cylinder of material having an outer diameter and an inner diameter on the spindle and rotating the cylinder of material using the spindle;
moving the tool post such that the cylinder of material is aligned with the receiving channel in the roller swage body of the roller swage attachment and the swage rollers are aligned with the outer diameter of the cylinder of material;
moving the roller swage attachment toward the cylinder of material until the swage rollers engage the outer diameter of the cylinder of material;
swaging the cylinder of material with the swage rollers decreasing the outer diameter and inner diameter of and elongating a desired portion of the cylinder of material engaged by the swage rollers as the roller swage attachment is moved along the cylinder of material; and
moving the roller swage attachment away from the cylinder of material such that the swage rollers disengage the cylinder of material once the desired portion of the cylinder of material is swaged.

38. The method according to claim 37, further comprising moving the tool post traverse to the spindle such that roller swage attachment is out of the alignment with the cylinder of material to increase access to the swaged cylinder of material.
